(19) United States
(12) Patent Application Publication
(10) Pub. No.: US 2010/0201647 A1
(43) Pub. Date: Aug. 12, 2010

(54) CAPACITIVE TOUCH SENSOR

(75) Inventor: Frans Verweg, Heerlen (NL)

Correspondence Address: LIU & LIU, 444 S. FLOWER STREET, SUITE 1750, LOS ANGELES, CA, 90071, US

(73) Assignee: TPO Displays Corp., Chu-Nan (TW)

(21) Appl. No.: 12/436,673

(22) Filed: May 6, 2009

Related U.S. Application Data
(60) Provisional application No. 61/151,797, filed on Feb. 11, 2009.

(51) Int. Cl. G06F 3/045; B05D 5/12; B44C 1/22; B05D 3/00

(52) U.S. Cl. 345/174; 427/58; 216/13; 427/553

(57) ABSTRACT

The invention relates to a capacitive touch sensor for use with a display device. The capacitive touch sensor includes a first electrode layer including a plurality of first sensor elements. The capacitive touch sensor has a longitudinal direction and a transversal direction, and the plurality of first sensor elements are separated with respect to each other in the longitudinal direction and the transversal direction.

### CROSS REFERENCE TO RELATED APPLICATIONS

This application claims the benefit of U.S. Provisional Application No. 61/151,797 filed Feb. 11, 2009, the entirety of which is incorporated by reference herein.

### BACKGROUND OF THE INVENTION

1. Field of the Invention

The invention relates to a capacitive touch sensor for use with a display device.

2. Description of the Related Art

Touch panels are widely used to allow user interaction with electronic devices. In particular, a transparent touch panel can be used on top of a display device to allow a user to interact with the display device, e.g. to respond to a query shown as a pop-up on the display device by touching the displayed query, to select an item from a menu shown on the display device by touching a selected item, to scroll through a list of items, or even to provide a free-format input, e.g. draw an object on the display device, such as hand-written characters for inputting text. Touch panels are e.g. used in mobile phones, portable media players, gaming devices and other portable consumer appliances, as well as with visual interfaces in medical devices, ticket machines, in the field of automotive (dashboards), aerospace or various other general purpose computer displays.

It is noted that touching the touch panel may be construed as a person or other object being in physical contact with the touch panel, but in the context of this document it may also be associated with being in the vicinity of the touch panel. In this case, physical contact corresponds to a direct electrical connection allowing electrons to flow, possibly resulting in electrostatic discharges and/or sustained electric currents. The vicinity of the object is in this case defined by the distance at which no direct electrical connections is established but at which electromagnetic properties of the touch panel are observably altered due to inductive and/or capacitive effects.

A known capacitive touch sensor for use with a display device comprises a glass layer that is electrically insulating, provided with a first electrode comprising a plurality of first sensor elements on one face of the glass layer and a second electrode on the opposite face of the glass layer. When the known capacitive touch sensor and the display device are combined into a display module, the first electrode is facing the user and the second electrode is facing the display device. The first electrode and the second electrode are composed of one or more conductive materials that are transparent for electromagnetic radiation in the optical frequency range. Indium tin oxide (ITO) is an example of such a material. A thin layer of metal such as a gold film, could also serve this purpose. In an example of the known touch panel, the second electrode provides electromagnetic shielding from the low frequency electric and magnetic emission of the display device during use. The frequency is considered to be low in comparison to the higher optical frequencies of the electromagnetic radiation emanating from the display device. Evidently, the capacitive touch sensor should allow transmission of at least some optical frequencies for it to be able to serve its intended purpose.

In some known display modules, the display device is a liquid crystal display (LCD) device; in some other known display modules, the display device is an organic light emitting diode (OLED) display device.

Such construction of such a known display module with a known capacitive touch sensor may have a drawback that the capacitive touch sensor contributes considerably to the combined thickness of the capacitive touch sensor and display device. Such construction may have a drawback that the capacitive touch sensor causes a deterioration of the display quality as seen by the user, due to the optical absorption and dispersion in the additional transparent layer.

According to the prior art, display modules may be constructed in many different ways. FIGS. 1a and 1b, which will described in more detail below, show an apparatus having a capacitive touch sensor on top of a display device.

FIGS. 1a and 1b schematically show an apparatus 1. The apparatus 1 comprises a display device 2, a capacitive touch sensor 3, and an apparatus controller 4 arranged to operate the capacitive touch sensor 3 and to operate the display device 2. The arrangement of display device 2 and capacitive touch sensor 3 may be referred to as a display module 40.

The apparatus 1 may further comprise e.g. a keypad 6 arranged for accepting user input for controlling the apparatus 1, a radio 7 arranged for sending and receiving messages such as voice messages, text messages and/or images, and a camera 8 arranged for taking images, and a scroll ball 9 for accepting further user input for controlling the apparatus 1.

The apparatus 1 may e.g. be a mobile phone, as shown in FIG. 1a, a digital still-picture camera, a car navigation system, a mobile DVD-player, a gaming device, or another hand-held consumer appliance, a television, a computer monitor, another large-screen consumer electronics device, or a professional appliance.

The display device 2 comprises a display 10 comprising a plurality of pixels arranged to be driven with pixel drive values, and a display controller 16 arranged to receive color input values of input image pixels of an input image and to drive the display 10 with pixel drive values. The display controller 16 is arranged to electrically communicate with column drivers 12 and row drivers 14, for driving the plurality of pixels of the display 10 with the pixel drive values according to known methods. The display controller 16 may be arranged to receive an input image from the apparatus controller 4 and use said input image to drive the display 10. The input image may alternatively be generated, as a whole or part of it, by the display controller 16, e.g. for providing test images. The input image may e.g. represent a menu, which may e.g. be displayed on the display using a set of icons 5. In the example shown, the display device further comprises a light source 20 and a backlight controller 22. The backlight controller 22 is arranged to electrically communicate with the display controller 16 and/or the apparatus controller 4, and with the light source 20. The light source 20 is arranged to illuminate the display 10 when driven by the backlight controller 22. In this example, the display 10 is an LCD display. It is appreciated that any suitable alternative display 10 may be used, such as for instance an OLED display, in which case the light source 20 and backlight controller 22 are omitted.

The capacitive touch sensor 3 comprises a transparent touch panel 30, a sensor controller 34 and a touch driver 36. The sensor controller 34 is arranged to electrically communicate with the touch driver 36 connected to the electrodes (not shown) on the touch panel 30, for operating the touch panel 30 according to known methods. The sensor controller 34 may in particular be arranged to detect a position on the touch panel 30 of a touch input to the touch panel 30. In alternative embodiments, the sensor controller 34 may be arranged to detect whether the touch panel 30 is touched or not.

Detection of a touch may for instance be realized by successively charging the plurality of first electrodes and the second electrodes. By analyzing the charging or subsequent discharging characteristics of the plurality of first electrodes and second electrodes, a touch can be determined, as a touch will locally influence the charging and discharging behavior of the electrodes. By combining information about which of the first and second electrodes are touched, a touch location can be determined.

The display 10 is positioned behind the touch panel 30, allowing a user to see the display 10 through the touch panel 30. When the display 10 shows a menu with icons 5, the user can thus see the icons 5 and touch a selected icon using his finger or e.g. a stylus for selecting the icon. When the icon 5 represents an application, the processing application may be launched when the icon is selected and the user may use his finger, or the stylus, to input information to the touch panel 30, thus composing an image associated with the information which is displayed on the display 10.

It will be appreciated that alternative modes of operating the touch panel 30 and alternative modes of cooperation between the display device 2 and the touch sensor 3 may be used in addition to or instead of the described modes.

It will be appreciated that the blocks shown in FIG. 1b may be implemented as individual hardware units, but that various blocks may alternatively be integrated into a single hardware unit. E.g., the display controller 16 and the sensor controller 34 may be integrated in a combined controller unit.

FIG. 2 schematically shows a prior art configuration of a capacitive touch sensor 80 and a display device 90 in an apparatus 1.

The apparatus 1 comprises a housing 300 having a transparent window plate 140 covering the capacitive touch sensor 80 for protecting the capacitive touch sensor 80 and for allowing as user to view the display through the transparent window plate 140 and the capacitive touch sensor 80. The capacitive touch sensor 80 comprises a transparent glass plate 83. A first electrode 81 comprising a plurality of first sensor elements 85 is provided on the glass plate 83 at a front side of the capacitive touch sensor 80, i.e. at the side facing the transparent window plate 140. A second electrode 82 is provided as a single electrode on the glass plate 83 at a back side of the capacitive touch sensor 80, i.e. at the side facing the display device 90.

The first electrode 81 and the second electrode 82 are composed of a transparent conductive material, e.g. ITO. The plurality of first sensor elements 85 and the second electrode 83 are connected via the touch driver 36 to the sensor controller 34. The sensor controller 34 is arranged to determine a position on the capacitive touch sensor of a touch input provided by a user to the transparent window plate 140, coupling to the capacitive touch sensor 80, from the plurality of first sensor elements 85 of the first electrode 81 and the second electrode 82 using e.g. known methods. The second electrode 82 acts as a shielding between the capacitive touch sensor 80 and the display device 90, and aims to prevent disturbances in the capacitive touch sensor 80 caused by operating the display device 90 or other components in the apparatus 1.

The display device 90 may be a known LCD-type display comprising, in this example, a back plate 92 comprising an active matrix of pixels, a front plate 94, a polarizer 98, an LCD layer 96 sandwiched between the back plate 92 and front plate 94, and a backlight system 91. The polarizer 98 is provided at a front side of the display device 90. The backlight system 91 delivers light to the back plate 92, to which the polarizer may be attached. The backlight 91 system may e.g. comprise a wave guide parallel to the back plate, a light source arranged at a side of the wave guide for emitting light into the waveguide, and an input polarizer between the wave guide and the back plate 92 for delivering polarized light to the back plate 92. Of course, many suitable alternatives may be conceived.

The arrangement of the capacitive touch sensor 80 with the display device 90 may be referred to as a display module. The known display module of FIG. 2 thus comprises a plurality of relatively thick optically transparent layers, such as the transparent window plate 140, the glass plate 83 of the capacitive touch sensor 80, the polarizer 98, the front plate 94 and the back plate 92. Each of these optically transparent layers may adversely affect an optical quality of the image being viewed through them by a user, especially at the interfaces between two layers.

In FIG. 2, the transparent window plate 140, the capacitive touch sensor 80 and the display device 90 are shown with a first small spacing in between the transparent window plate 140 and the capacitive touch sensor 80 and a second small spacing in between the capacitive touch sensor 80 and the display device 90. These spacings are drawn to indicate that the transparent window plate 140, the capacitive touch sensor 80 and the display device 90 need not be laminated together, but may e.g. be clamped together to be in close contact or with a marginal spacing only.

These spacings may be filled with optically clear adhesive layers. Such optically clear adhesive layers provide mechanical and optical contact between the transparent window plate 140 and the capacitive touch sensor 80 or capacitive touch sensor 80 and the display device 90. Also, the polarizer 98 may be laminated with an optically clear adhesive layer to the front plate 94 of the LCD-type display.

Alternative configurations of a capacitive touch sensor and a display device in an apparatus are known to a skilled person. For instance, the glass plate as described above may be replaced by a polarizer forming a sensor dielectric layer. A first electrode comprising a plurality of first sensor elements may be provided on the transparent window plate in a first sensor electrode layer at a back side of the transparent window plate. A second electrode may be provided as a single electrode in a second sensor electrode layer on a front surface of the display device. In such a configuration, the display device lacks the polarizer; the function of the polarizer is now performed by the sensor dielectric layer in the capacitive touch sensor and thus comprises less relatively thick optically transparent layers which may result in an improved image quality.

Again, the spacings that may be present between layers, may be filled with optically transparent adhesive layers.

It will be appreciated that the display device may be replaced by an OLED-type display device, or any other suitable type of display device.

Also, according to the prior art first sensor electrode layers may be formed in many ways. For instance, FIG. 3a shows an arrangement of a capacitive touch sensor. In FIG. 3a, the first sensor electrode layer 110 is formed of three stacked layers: layer 110X comprising a first plurality of sensor elements arranged as rows, layer 110Y comprising a second plurality of sensor elements arranged as columns, i.e. substantially transversally to the rows, and dielectric layer 110D positioned in between layer 110X and layer 110Y for electrically isolating layer 110X and 110Y from each other. In other words, the first plurality of sensor elements are separated with respect to each other in a first direction and the second plurality of sensor elements are separated with respect to each other in a second direction. A position of a touch input may thus be determined along the first direction from the first plurality of sensor elements in layer 110X and along the second direction from the second plurality of sensor elements in layer 110Y. According to the example provided, the second electrode is provided as a second sensor electrode layer 120, which serves to shield the capacitive touch sensor 100 from the display device 200 (not shown in FIG. 3a; positioned beneath second electrode layer 120).

FIG. 3b shows an alternative arrangement of the capacitive touch sensor. In FIG. 3b, the first sensor electrode layer 110 comprises a single layer 110X comprising a first plurality of sensor elements arranged as rows. The second sensor electrode layer 120 is formed of three stacked layers: layer 120S serving to shield the capacitive touch sensor 100 from the display device 200, layer 120Y comprising a second plurality of sensor elements arranged as columns, i.e. substantially transversally to the rows in layer 110X, and a dielectric layer 120D positioned in between layer 120Y and layer 120S for electrically isolating layer 120Y and 120S from each other. A position of a touch input may thus be determined along a first direction from the first plurality of sensor elements in layer 110X and along a second direction from the second plurality of sensor elements in layer 120Y.

So, according to the prior art, relatively complicated electrode layers are required, which are relatively difficult and expensive to manufacture. Also, the prior art solutions require relatively sophisticated manufacturing equipment.

### BRIEF SUMMARY OF THE INVENTION

According to an aspect there is provided a capacitive touch sensor for use with a display device, the capacitive touch sensor comprising a first electrode layer comprising a plurality of first sensor elements wherein the capacitive touch sensor has a longitudinal direction and a transversal direction, and the plurality of first sensor elements are separated with respect to each other in the longitudinal direction and the transversal direction.

This provides a relatively low cost touch panel structure. The capacitive touch sensors are coplanar deposited on a transparent substrate (such as glass). The sensor material may be ITO. This provides an easy layout, which does not require bridges or metal tracks, which makes it relatively easy to manufacture.

According to a further aspect there is provided a method of manufacturing a capacitive touch sensor according to the above. An exemplary embodiment of the method is described in the following. A pre-exposure process is performed. An exposure action is performed. A post-exposure process is performed.

This provides a relatively easy method of manufacturing, as the pre-exposure process, the exposure action and the post-exposure process only needs to be performed once, because of the coplanar structure of the capacitive touch sensor.

A detailed description is given in the following embodiments with reference to the accompanying drawings.

### BRIEF DESCRIPTION OF THE DRAWINGS

The invention can be more fully understood by referring to the following detailed description and examples with references made to the accompanying drawings, wherein:

FIG. 1a and FIG. 1b schematically show an apparatus having a capacitive touch screen on top of a display device;

FIG. 2 schematically shows a capacitive touch sensor and a display device in an apparatus according to the prior art;

FIG. 3a-FIG. 3b schematically show alternative arrangements according to the prior art,

FIGS. 4, 5a, 5b, and 6 schematically depict embodiments.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

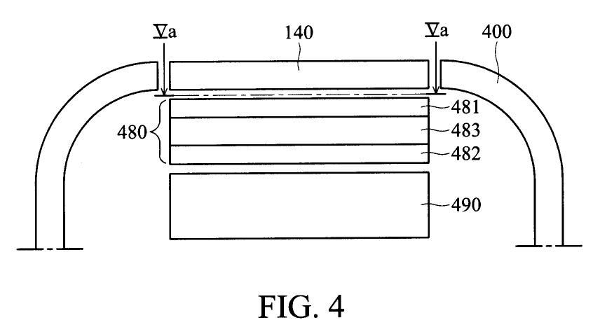

FIG. 4 schematically depicts a housing 400 having a transparent window plate 140 for protective covering of the capacitive touch sensor 480 and for allowing the user to view a display device 490 through the transparent window plate 140 and the capacitive touch sensor 480. The capacitive touch sensor 480 comprises a transparent electrically insulating layer 483. A first electrode layer 481 comprising a plurality of first sensor elements 484 is provided on the transparent electrically insulating layer 483 at a front side of the capacitive touch sensor, i.e. at the side facing the transparent window plate 140. A second electrode layer 482 comprising an electrically conducting substrate is provided at a back side of the capacitive touch sensor 480, i.e. at the side facing the display device 490.

The display device 490 may be any kind of display device, such as a LED display device, an OLED display device or a LCD-device.

The first electrode layer 481 and the second electrode layer 482 may be composed of a material that is transparent for electromagnetic radiation in the optical frequency range. ITO is an example of such a material. A thin layer of metal such as a gold film, could also serve this purpose.

The second electrode layer 482 may act as a shielding between the capacitive touch sensor 480 and the display device 490, and aims to prevent electromagnetic disturbances in the capacitive touch sensor 480 caused by the operation of the display device 490 or other components.

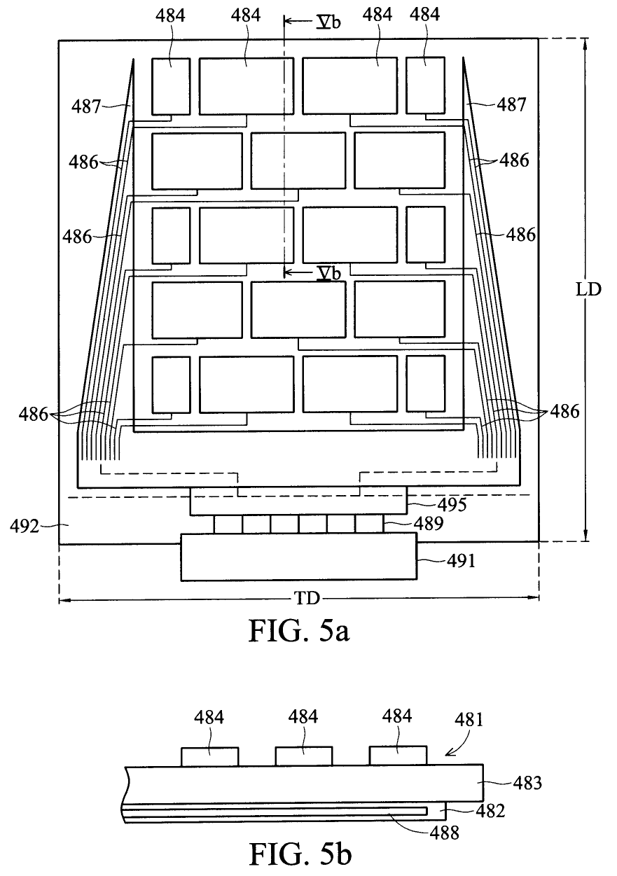

The first electrode layer 481 comprises a plurality of first sensor elements 484 provided in a coplanar configuration. An example of such a coplanar configuration of the plurality of first sensor elements 484 is schematically shown in FIGS. 5a and 5b.

As can be seen in FIG. 5a, the capacitive touch sensor has a longitudinal direction LD and a transversal direction TD. The first sensor elements 484 are all separated from each other in both the longitudinal direction LD and the transversal direction TD. This allows providing the plurality of first sensor elements 484 in a coplanar configuration, confining the plurality of first sensor elements 484 to a two dimensional plane. The coplanar configuration may correspond to a two-dimensional periodic or semi-periodic structure, such as a matrix or a brick pattern, bounded by the rims of the first electrode layer 481. Alternatively, the coplanar configuration may lack any predefined structure.

So, according to an embodiment there is provided a capacitive touch sensor 480 for use with a display device 490, the capacitive touch sensor comprising a first electrode layer 481 comprising a plurality of first sensor elements wherein the first electrode layer 481 has a longitudinal direction and a transversal direction, and the plurality of first sensor elements 484 are separated with respect to each other in the longitudinal direction and the transversal direction. The longitudinal direction LD and transversal direction TD may be substantially perpendicular with respect to each other.

Accordingly, the plurality of first sensor elements are coplanar first sensor elements 484, provided in a coplanar configuration. This means that the first sensor elements 484 are all located in a single plane, allowing easy manufacturing techniques.

In FIG. 5a a matrix-like pattern or brick pattern with tetragonal symmetry is shown, comprising a plurality of first sensor elements 484.

It will be understood that more or less coplanar first sensor elements 484 may be provided, depending on the required size and accuracy of the touch sensor.

The coplanar first sensor elements 484 may be substantially square shaped, although any other shape may be used as well. The coplanar first sensor elements 484 may for instance have the shape of a triangle, a tetragon or a hexagon.

FIG. 5b schematically depicts a cross sectional view of FIG. 5a, showing a plurality of sensor elements 484 provided on a transparent electrically insulating layer 483. Further shown is the second electrode layer 482.

Also, the first electrode layer 481 comprises a plurality of electrically conducting tracks 486 to enable the execution of charging and discharging cycles of the individual first sensor elements 484, as will be understood by a skilled person. The electrically conducting tracks 486 are provided in a track area 487.

So, according to an embodiment, the first electrode layer 481 further comprises electrically conducting tracks 486 that electrically connect at least one of the first sensor elements 484, to enable the execution of charging and discharging cycles of the coplanar first sensor elements 484 for detecting a touch. The tracks 486 are arranged to connect the at least one of the coplanar first sensor elements 484 to a controller.

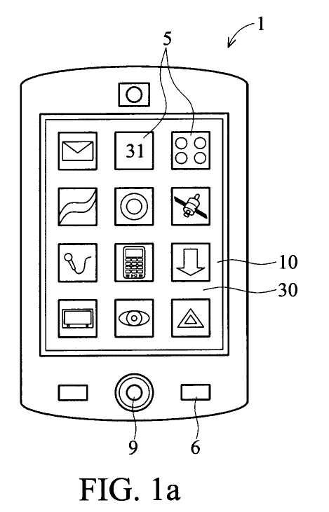

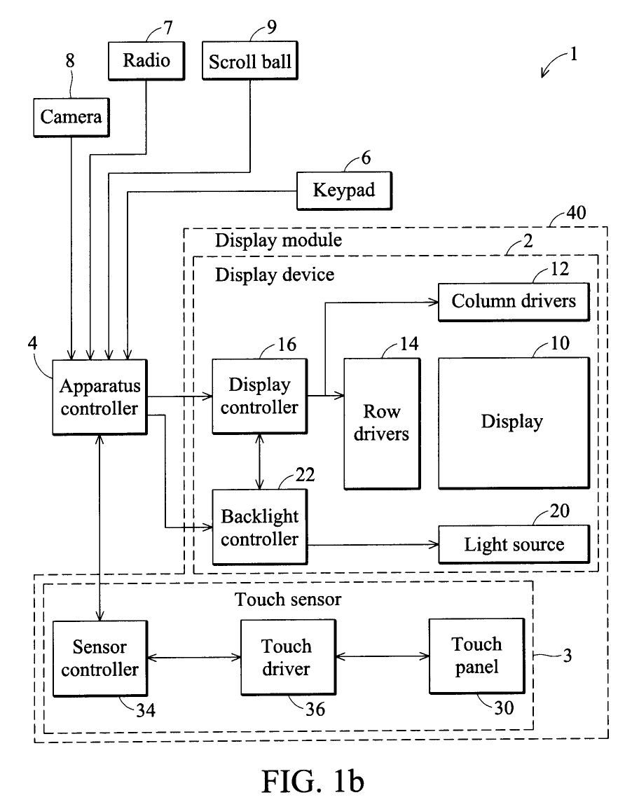

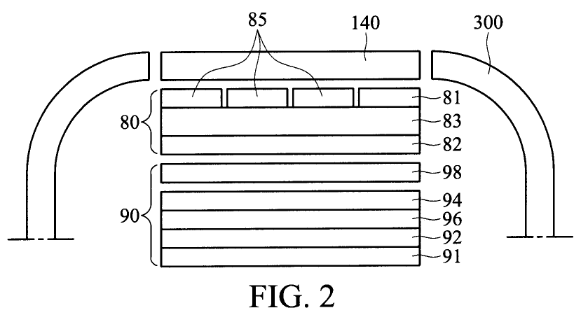

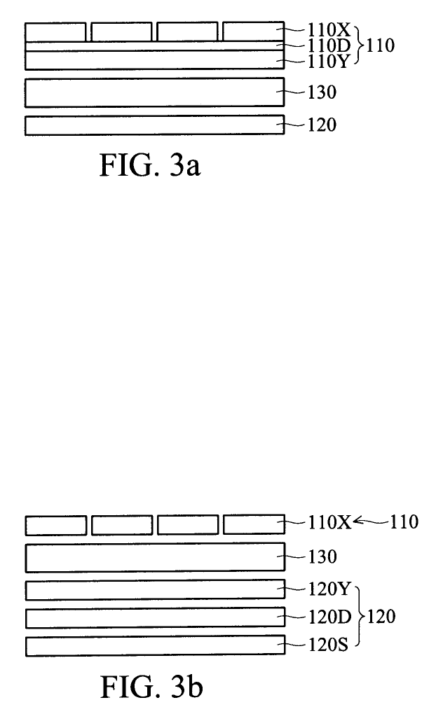

As will be understood by a skilled person, the controller may be arranged to control the charging and discharging cycles of the sensor elements and arranged to detect a touch based on analyzing the charging and/or discharging behavior. The controller may be a sensor controller 34 as shown in FIG. 1b.

An active shielding layer may be deposited on the back side of the transparent plate, forming the second electrode layer 482. The term active shielding layer is used in this text to refer to a shielding layer that is not connected to ground. Controller IC will be connected with ACF on the glass plane. (COG).

Both the first electrode layer 481 and the second electrode layer 482 may be connected via the touch driver 36 to the sensor controller 34. This connection may be established by providing a so-called slim chip on glass (COG) controller 495 and an interconnection foil 491, as shown in FIG. 5b. The COG controller 495 and the interconnection foil 491 may be connected via connection tracks 489. The COG controller 495, the connection tracks 489 and the interconnection foil 491 may all be provided on a contact ledge 492. Such a slim COG IC reduces the number of interconnections that are required at the interconnection foil 491. This is cost-effective, and improves the form factor.

The sensor controller 34 is arranged to determine a position on the capacitive touch sensor of a touch input provided by a user to the transparent window plate 140, coupling to the capacitive touch sensor 480, from the plurality of first sensor elements 484 of the first electrode 481 and the second electrode 482 using e.g. known methods.

It will be understood that the sensor controller 34 can now determine a position by simply determining which of the first sensor elements 484 are touched. Since the coplanar first sensor elements 484 are provided in a coplanar configuration there is no need to combine information from different layers, where one layer comprises sensor elements arranged as rows, and another layer comprises sensor elements arranged as columns. This results in a relatively easy signal processing by the sensor controller 34. The sensor controller 34 may be arranged to subsequently provide the first sensor elements 484 with a charging signal for altering the amount of electric charge contained by the respective first sensor elements 484, determine charge characteristics of the respective first sensor elements 484 in response to providing the charging signal, comparing the respective charge characteristics with a reference charge characteristic, and determining a touch input of a first sensor elements 484 of which the corresponding charge characteristic deviates from the reference charge characteristic by more than predetermined threshold.

The charge characteristic may for instance be one of a charging time and a discharging time. The reference charge characteristic may be obtained from memory, from a reference first sensor element 484 or from a second sensor element provided in a second electrode layer 482.

According to a further embodiment, a spatial configuration of the electrically conducting tracks 486 is substantially coplanar within the first electrode layer 481. In other words, the electrically conducting tracks 486 and the plurality of coplanar first sensor elements 484 are all provided in the same plane. It will be understood that the term coplanar also implies that the lay-out of the coplanar first sensor elements 484 and the electrically conducting tracks 486 is such that no intersections, bridges and the like are needed. Both can thus be manufactured in a single manufacturing step.

According to an example a capacitive touch sensor may be provided, having an outline of 51 mm×92 mm (measured in the longitudinal direction and transversal direction respectively), with an active area of 46.8×84.2 mm. The term active area is here used to indicate the area comprising sensors, and not the area in which a touch my be determined (which may extend beyond the active area). On such an active area, ninety coplanar first sensor elements 484 may be formed, arranged in twelve rows. The coplanar first sensors elements 484 may be square shaped and may have a size of approximately 6.2×6.8 or 6.9 mm, while some of the first sensor elements 484 be half-size, for instance at the end of each other row and may have a size of approximately 3.2×6.8 or 6.9 mm (as will become clear from FIG. 5a).

The contact ledge may be approximately 4.75 mm (in the longitudinal direction as shown in FIG. 5a). The first sensor elements 484 are electrically isolated with respect from each other, for instance by providing an interspacing in between the individual first sensor elements 484. The minimum interspacing between adjacent coplanar first sensor elements 484 may be approximately 10 μm in the row direction (transversal direction TD as shown in FIG. 5a). In the longitudinal direction LD (as shown in FIG. 5a), the interspacing between adjacent coplanar first sensor elements 484 may vary between 10 μm-60 μm, depending on the amount of tracks 486 for which room needs to be provided.

According to an embodiment, the respective values for the electrical resistance of individual electrically conducting tracks 486 are substantially equal. In other words, the resistance of the tracks to the sensors is balanced.

In other words, a balanced electrical track resistance is provided in between the slim COG controller 495 and the first sensor elements 484.

From FIG. 5a it can be seen that not all electrically conducting tracks 486 have similar lengths.

As described above, detection of a touch may be accomplished by successively charging and discharging the plurality of first sensor elements 484 and analyzing the charging characteristics. This may be done as explained above.

As the length and cross-sectional area of an electrically conducting track 486 influences the electrical resistance of the track 486, it is to be expected that tracks 486 with differing geometrical properties result in differing charging characteristics. This makes it relatively difficult to accurately detect a touch by analyzing and comparing charging characteristics of first sensor elements 484.

Therefore, it is advantageous to form the electrically conducting tracks 486 in such a way that the electrical behavior of the respective tracks 486 is substantially equal. This can be accomplished by constructing the electrically conducting tracks 486 in such a way that the electrical resistances of the individual tracks 486 are substantially equal, with respect to each other. This makes it relatively easy to analyze the determined charging and/or discharging characteristics and allows all electrodes to be charged in a similar way.

Constructing electrically conducting tracks 486 with different lengths and substantial equal electrical resistances can be done by providing electrically conducting tracks 486, wherein the length and the cross-sectional area of at least one of the electrically conducting tracks 486 are arranged such as to obtain substantially equal values for the electrical resistance of individual electrically conducting tracks. This may be achieved by providing the tracks with a cross sectional area A that is proportional to their length L, such that L/A=C, where C is a constant. Instead of the cross sectional area A, the width W of the track may be used: L/W=C′.

Thus, a relatively long electrically conducting track 486 is made relatively wide and a relatively short track 486 is made relatively narrow. The width W of electrically conducting tracks 486 may vary between 15 μm (length of 22,5 mm) to 65 μm (length of 100 mm).

It is further noted that the tracks 486 may also have their own capacitance that may respond to a touch. In order to minimize this effect, the tracks 486 may be made relatively small, occupying relatively little surface area. According to a further embodiment, the capacitive touch sensor comprises a shielding coating at the position of the electrically conducting tracks 486 to shield the electrically conducting tracks 486 from a touch. The shielding coating may be arranged to cover at least part of the tracks 486 in the direction away from the display device 490. The shielding coating may for instance be a metallic layer, to shield the tracks 486 from a touch.

As explained above, the capacitive touch sensor further comprises a second electrode layer 482 and a transparent electrically insulating layer 483. The second electrode layer 482 comprises a shielding substrate 488. The transparent electrically insulating layer 483 is arranged in between the first electrode layer and the second electrode layer. The shielding substrate 488 may be arranged to shield the first electrode layer 481 from the frequency components in the electromagnetic field originating from the display device 490 that may influence the charge and discharge behavior of the first sensor elements 484.

The controller (sensor controller 34) may be in electrical communication with the second electrode layer 482. The second electrode layer 482 may be formed as a single electrode.

As mentioned above, the second electrode 482 may act as an active shielding (i.e. not being connected to ground). However, alternative configurations are known to a skilled person.

As explained above, the capacitive touch sensor may further comprise a transparent window plate 140 for use as a cover window, wherein the first electrode layer 481 is arranged behind the transparent protective layer from a user's perspective.

As explained above, the first electrode may at least partially be composed of ITO. The second electrode 482 may also be at least partially composed of ITO.

Open areas, in between the first sensor elements 484, may be filled with dummy ITO's, providing a uniform transmission coefficient to provide an uniform sight for a user.

The capacitive touch sensor as described above may be used to form a display module 40 comprising a display device 490 and a capacitive touch sensor 480 according to any one of above embodiments. Such a display module may be used in an apparatus 1 comprising a display module 40 and an apparatus controller 4. The display module 40 accords to the above. The apparatus controller 4 is arranged to operate the display device 490 and the capacitive touch sensor 480. The apparatus can be a mobile phone, portable media player, gaming device and other portable consumer appliance, as well as with visual interfaces in medical device, ticket machine, in the field of automotive (dashboards), aerospace or various other general purpose computer display.

The above described embodiments allow low cost manufacturing of a capacitive touch sensor, using relatively easy manufacturing machines. Advantage of the above described embodiments is that this provides a lay-out that can be manufactured in a single exposure cycle, such an exposure cycle may comprise a pre-exposure process 700, an exposure action 710, and a post-exposure process 720.

Thus there is provided a method of manufacturing a capacitive touch sensor according to the capacitive touch sensor 480 for use with a display device 490. The capacitive touch sensor 480 comprises a first electrode layer 481 comprising a plurality of first sensor elements 484. The capacitive touch sensor 480 has a longitudinal direction and a transversal direction. The plurality of first sensor elements 484 are separated with respect to each other in the longitudinal direction and the transversal direction. The method of manufacturing the capacitive touch sensor is described in the following. A pre-exposure process is performed. An exposure action is performed. A post-exposure process is performed.

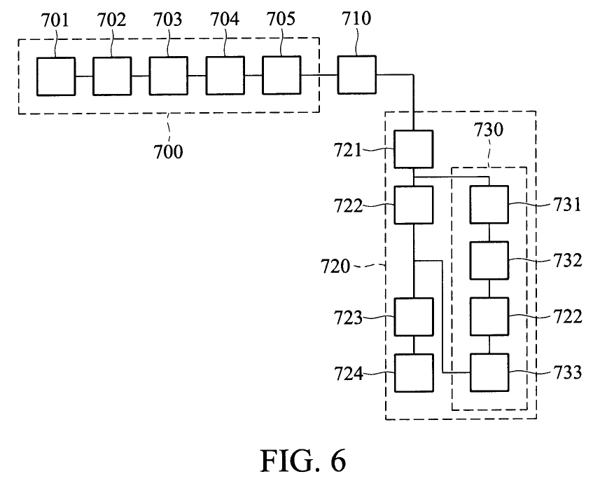

The exposure cycle is schematically shown in FIG. 6. In step 700, the pre-exposure process is performed. In step 710, the exposure action is performed. In step 720, the post-exposure process is performed. A more detailed example of the exposure cycle is described below with reference to FIG. 6.

As shown in FIG. 6, the step 700 may comprise steps 701˜705. In step 701, a substrate is provided, e.g. double sided ITC glass. The substrate is loaded into a lithographic apparatus (step 702). The substrate is cleaned (step 730). A roller coating action 704 is performed (step 704). A pre-bake action is performed (step 705).

The pre-exposure process (i.e. step 700) may be followed by the exposure action (i.e. step 710), in which a pattern is projected onto the first electrode layer 481 corresponding to a plurality of first sensor elements wherein the plurality of first sensor elements 484 are separated with respect to each other in the longitudinal direction and the transversal direction and with the electrically conducting tracks 486. The exposure action (i.e. step 710) may comprise one exposure or two consecutive exposures to project the entire pattern. The exposure action (i.e. step 710) may further comprise loading the substrate into an exposure tool, performing necessary measurements and leveling actions, as will be understood by a skilled person, and unloading the substrate.

After the exposure action (i.e. step 710), the post-exposure process (i.e. step 720) is performed. This shown in more detail in FIG. 6, in which two alternative flows are depicted, representing two alternative post exposure processes. The post-exposure process (i.e. step 720) may for instance comprise steps 721˜724. A developing action is performed (step 721). An UV/post-bake action is performed (step 722). An etching/strip action is performed (step 723). And finally, the substrate is unloaded from the lithographic apparatus (step 724).

Alternatively there is provided a method, wherein the post-exposure process (i.e. step 720) further comprises a coating process (i.e. step 730), in which a shielding coating is applied to the substrate, covering at least parts of the electrically conducting tracks 486.

The post-exposure process (i.e. step 720) may comprise an in-line coating process (i.e. step 730). The in-line coating process (i.e. step 730) may comprise a roller coating action (i.e. step 732), in which a shielding coating is applied to the substrate, covering at least parts of the electrically conducting tracks 486.

As described above, the shielding coating may for instance be a metallic layer, to shield the tracks 486 from a touch, minimize the influence of the tracks on the total experienced capacitance of the first sensor elements 484.

The in-line coating process (i.e. step 730) may comprise steps 731˜733. A first flipping action (i.e. step 731) performed just before the roller coating action (i.e. step 732) and a second flipping action (i.e. step 733) performed just after the roller coating action (i.e. step 732). Performing the UV/post-bake action (i.e. step 722) is done in between steps 732 and 733.

In between steps 721 and 722/731 a buffering action may be performed. The above described exposure cycle is performed only once to create a capacitive touch sensor. No second exposure cycle is needed to create a sufficient first electrode layer 481. As no different X and Y-layers are needed, no second exposure cycle is required.

It should be noted that the above-mentioned embodiments illustrate rather than limit the invention, and that those skilled in the art may conceive alternatives without departing from the scope of the appended claims. E.g., alternative layouts of sensor elements may be used than those explicitly described above without departing from the scope of the invention and the appended claims. In the claims, any reference signs placed between parentheses shall not be construed as limiting the claim. Throughout this document, the term “and/or” includes any and all combinations of one or more of the associated listed items.

What is claimed is:

1. A capacitive touch sensor for use with a display device and having a longitudinal direction and a transversal direction, comprising:
a first electrode layer comprising a plurality of first sensor elements, wherein the plurality of first sensor elements are separated with respect to each other in the longitudinal direction and the transversal direction.

2. The capacitive touch sensor as claimed in claim 1, wherein the plurality of first sensor elements are coplanar first sensor elements, provided in a coplanar configuration.

3. The capacitive touch sensor as claimed in claim 1, wherein the first electrode layer further comprises electrically conducting tracks that electrically connect at least one of the first sensor elements, to enable the execution of charging and discharging cycles of the coplanar first sensor elements for detecting a touch.

4. The capacitive touch sensor as claimed in claim 3, wherein the tracks are arranged to connect the at least one of the coplanar first sensor elements to a controller.

5. The capacitive touch sensor as claimed in claim 3, wherein a spatial configuration of the electrically conducting tracks is substantially coplanar within the first electrode layer.

6. The capacitive touch sensor as claimed in claim 3, wherein the respective values for the electrical resistance of individual electrically conducting tracks are substantially equal.

7. The capacitive touch sensor as claimed in claim 6, wherein the length and the cross-sectional area of at least one of the electrically conducting tracks are arranged such as to obtain substantially equal values for the electrical resistance of individual electrically conducting tracks.

8. The capacitive touch sensor as claimed in claim 3, further comprising a shielding coating at the position of the electrically conducting tracks to shield the electrically conducting tracks from a touch.

9. The capacitive touch sensor as claimed in claim 1, further comprising:
a second electrode layer comprising a shielding substrate, and
a transparent electrically insulating layer arranged in between the first electrode layer and the second electrode layer.

10. The capacitive touch sensor as claimed in claim 9, wherein a sensor controller is in electrical communication with the second electrode layer (482).

11. The capacitive touch sensor as claimed in claim 1, further comprising a transparent window plate for use as a cover window, wherein the first electrode layer is arranged behind the transparent protective layer from a user's perspective.

12. The capacitive touch sensor as claimed in claim 1, wherein the first electrode is at least partially composed of 110.

13. A display module comprising a display device and a capacitive touch sensor as claimed in claim 1.

14. An apparatus comprising:
a display module according to claim 12, and
an apparatus controller arranged to operate the display device and the capacitive touch sensor.

15. The apparatus as claimed in claim 14, wherein the apparatus is a mobile phone, a portable media player, a gaming device, a portable consumer appliance, a visual interface in medical device, a ticket machine, a automotive display, a aerospace display or various other general purpose computer display.

16. A method of manufacturing a capacitive touch sensor according to claim 1, the method comprising:
performing a pre-exposure process,
performing exposure action, and
performing a post-exposure process.

17. The method as claimed in claim 16, wherein the post-exposure process further comprises a coating process, in which a shielding coating is applied to the substrate, covering at least parts of the electrically conducting tracks.

18. The method as claimed in claim 16, wherein the pre-exposure process comprises:
providing a substrate;
loading the substrate into a lithographic apparatus;
cleaning the substrate;
performing a first roller coating action; and
performing a pre-bake action.

19. The method as claimed in claim 18, wherein the post-exposure process comprises:
performing a developing action;
performing a first UV/post-bake action;
performing an etching/strip action; and
unloading the substrate from the lithographic apparatus.

20. The method as claimed in claim 16, wherein the post-exposure process further comprises an in-line coating process, the in-line coating process comprises:
performing a first flipping action;
performing a second roller coating action;
performing a second flipping action; and
performing a second UV/post-bake action;wherein the developing action and the first UV/post-bake action are a buffer action or the developing action and the first flipping action are a buffer action.
